(19) United States
(12) Patent Application Publication
(10) Pub. No.: US 2025/0191576 A1
(43) Pub. Date: Jun. 12, 2025

(54) TRAINING DEVICE, ESTIMATION DEVICE, TRAINING METHOD, ESTIMATION METHOD, TRAINING PROGRAM, AND ESTIMATION PROGRAM

(71) Applicant: NIPPON TELEGRAPH AND TELEPHONE CORPORATION, Tokyo (JP)

(72) Inventors: Akira MORIKAWA, Musashino-shi, Tokyo (JP); Ryo ISHII, Musashino-shi, Tokyo (JP); Hajime NOTO, Musashino-shi, Tokyo (JP)

(73) Assignee: NIPPON TELEGRAPH AND TELEPHONE CORPORATION, Tokyo (JP)

(21) Appl. No.: 18/840,504

(22) PCT Filed: Feb. 24, 2022
(86) PCT No.: PCT/JP2022/007727

§ 371 Date: Aug. 22, 2024

(51) Int. Cl. G10L 15/06

(52) U.S. Cl. CPC G10L 15/063

(57) ABSTRACT

A learning device includes processing circuitry configured to acquire speech data of a speaker, information on the speaker, conversation data of a listener, and information on the listener, and create a learned model of estimating a quick response of the listener to a conversation of the speaker using the information acquired with a quick response included in the conversation data of the listener as correct answer data.

### TECHNICAL FIELD

The present invention relates to a learning device, an estimation device, a learning method, an estimation method, a learning program, and an estimation program.

### BACKGROUND ART

There is a conventional technology of a conversation system that generates a speech responding to a speech of a user and achieves smooth interaction between the user and the system. In such a conversation system, quick response is an important element, and for example, there is a technology of randomly generating a quick response (for example, see Patent Literature 1).

### CITATION LIST

### Patent Literature

Patent Literature 1: Japanese Laid-open Patent Publication No. 2018-22075 A

### SUMMARY OF INVENTION

### Technical Problem

However, the conventional technology has a problem that a more natural quick response cannot be generated as a listener. For example, in the conventional technology, there is a limit to performing a speech at an appropriate timing, and there is a problem that the content of the speech is far from a natural quick response.

The present invention has been made in view of the above, and an object thereof is to provide a learning device, an estimation device, a learning method, an estimation method, a learning program, and an estimation program capable of generating a more natural quick response as a listener.

### Solution to Problem

In order to solve the above-described problems and achieve the object, a learning device of the present invention includes: an acquisition unit that acquires speech data of a speaker, information on the speaker, conversation data of a listener, and information on the listener; and a creation unit that creates a learned model of estimating a quick response of the listener to a conversation of the speaker using the information acquired by the acquisition unit with a quick response included in the conversation data of the listener as correct answer data.

In addition, an estimation method is an estimation method performed by an estimation device, the estimation method including: an acquisition step of acquiring speech data of a speaker, and information on the speaker; and an estimation step of inputting the information acquired by the acquisition step as input data to a learned model of predicting a quick response of a listener from a conversation content of the speaker and estimating the quick response of the listener to the conversation of the speaker.

### Advantageous Effects of Invention

According to the present invention, it is possible to generate a more natural quick response as a listener.

### BRIEF DESCRIPTION OF DRAWINGS

FIG. 1 is a diagram for describing an outline of a learning device and an estimation device of the present embodiment.

FIG. 2 is a block diagram illustrating a configuration of the learning device of the present embodiment.

FIG. 3 is a block diagram illustrating a configuration of an estimation device of the present embodiment.

FIG. 4 is a diagram illustrating processing of estimating a quick response of a listener to a conversation of a speaker.

FIG. 5 is a flowchart illustrating an example of a processing procedure of learning processing.

FIG. 6 is a flowchart illustrating an example of a processing procedure of estimation processing.

FIG. 7 is a diagram illustrating a computer that executes a program.

### DESCRIPTION OF EMBODIMENTS

Hereinafter, embodiments of a learning device, an estimation device, a learning method, an estimation method, a learning program, and an estimation program according to the present application will be described in detail with reference to the drawings. Moreover, the present invention is not limited to the embodiment described below.

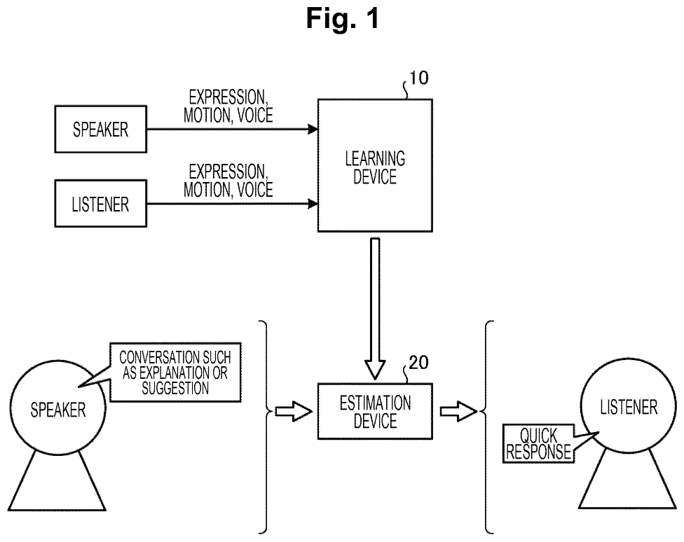

FIG. 1 is a diagram for describing an outline of a learning device and an estimation device of the present embodiment. As illustrated in FIG. 1, a learning device 10 acquires speech data of a speaker, information on the speaker, conversation data of a listener, and information on the listener, and creates a learned model of estimating a quick response of the listener to a conversation of the speaker using the acquired information with a quick response included in the conversation data of the listener as correct answer data and outputs the learned model.

For example, the learning device 10 acquires, as learning data, speech data (speech sentences) of a speaker and a listener, and multi-modal such as facial expressions, motions, voices, and the like. Then, the learning device 10 performs machine learning using the acquired information and creates a learned model (multimodal generator).

The estimation device 20 predicts a quick response of the listener from the conversation content of the speaker using the learned model created by the learning device 10. For example, the estimation device 20 acquires speech data of a speaker, and information on the speaker, and inputs the acquired information as input data to a learned model of predicting a quick response of the listener from a conversation content of the speaker and estimates the quick response of the listener to the conversation of the speaker. That is, the estimation device 20 inputs the multimodal of the speaker to the learned model (multimodal generator), and generates the multimodal of the listener.

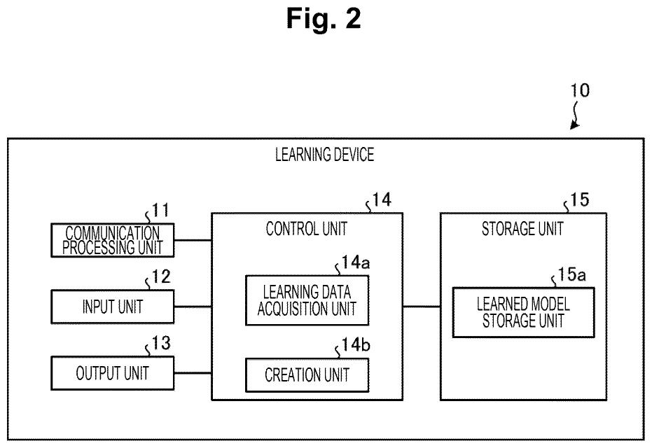

That is, the estimation device 20 can estimate a natural and appropriate back channel by using the multimodal of the speaker as an input. As described above, the learning device 10 can learn a quick response of the listener with respect to the speech of the speaker. Then, the estimation device 20 can generate a back channel (quick response) having more appropriate contents, and can generate a more natural reaction as a listener.

[Configuration of Learning Device] FIG. 2 is a block diagram illustrating a configuration of the learning device of the present embodiment. As illustrated in FIG. 2, a learning device 10 of the present embodiment includes a communication processing unit 11, an input unit 12, an output unit 13, a control unit 14, and a storage unit 15.

The communication processing unit 11 is implemented by a network interface card (NIC) or the like, and controls communication via an electric communication line such as a local area network (LAN) or the Internet.

The input unit 12 is implemented by using an input device such as a keyboard or a mouse and inputs various types of instruction information such as processing start to the control unit 14 in response to an input operation by an operator. The output unit 13 is implemented by a display device such as a liquid crystal display.

The storage unit 15 stores data and programs necessary for various types of processing by the control unit 14, and includes a learned model storage unit 15a. For example, the storage unit 15 is a semiconductor memory element such as a random access memory (RAM) or a flash memory, or a storage device such as a hard disk or an optical disk.

The learned model storage unit 15a stores a learned model learned by the creation unit 14b to be described later. For example, the learned model storage unit 15a stores, as a learned model, a back channel generator for estimating a quick response of a listener to a conversation of a speaker.

The control unit 14 includes an internal memory for storing a program defining various processing procedures and the like and required data, and executes various types of processing using the program and the data. For example, the control unit 14 includes a learning data acquisition unit 14a and a creation unit 14b. Here, the control unit 14 is an electronic circuit such as a central processing unit (CPU) or a micro processing unit (MPU), or an integrated circuit such as an application specific integrated circuit (ASIC) or a field programmable gate array (FPGA).

The learning data acquisition unit 14a acquires the speech data of the speaker and the information on the speaker, and the conversation data of the listener and the information on the listener. For example, the learning data acquisition unit 14a acquires any one or more of the expression, the motion, and the voice of the speaker as the information on the speaker, and acquires any one or more of the expression, the motion, and the voice of the speaker as the information on the listener. The learning data acquisition unit 14a may acquire, for example, image data of the face of the speaker or the entire speaker, or may acquire information such as the expression “smile” or the motion “absence” as the information of the expressions and the motions of the speaker and the listener.

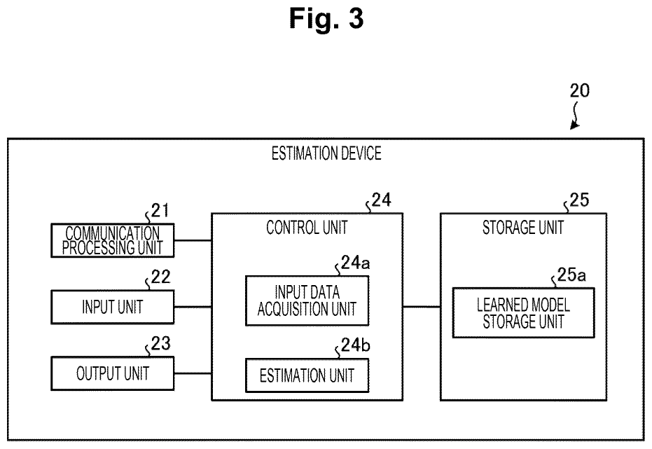

The creation unit 14b uses the information acquired by the learning data acquisition unit 14a to create a learned model of estimating a quick response of the listener to the conversation of the speaker using the quick response included in the conversation data of the listener as correct answer data. The creation unit 14b may use any method using the model as a learning method. Here, the quick response included in the conversation data of the listener is, for example, a speech such as “yes, yes, yes”, “yeah, yeah”, “good”, “I see”, “true”, “yeah”, “yes”, “oh”, “ooh”, “hmm”, “great”, or “what” included in the conversation data. Thereafter, the creation unit 14b stores the created learned model in the learned model storage unit 15a.

[Configuration of Estimation Device] FIG. 3 is a block diagram illustrating a configuration of an estimation device of the present embodiment. As illustrated in FIG. 3, the estimation device 20 of the present embodiment includes a communication processing unit 21, an input unit 22, an output unit 23, a control unit 24, and a storage unit 25.

The communication processing unit 21 is implemented by an NIC or the like, and controls communication via a telecommunication line such as a LAN or the Internet. The input unit 22 is implemented by using an input device such as a keyboard or a mouse and inputs various types of instruction information such as processing start to the control unit 24 in response to an input operation by an operator. The output unit 23 is implemented by a display device such as a liquid crystal display.

The storage unit 25 stores data and programs necessary for various types of processing by the control unit 24, and includes a learned model storage unit 25a. For example, the storage unit 25 is a semiconductor memory element such as a random access memory (RAM) or a flash memory, or a storage device such as a hard disk or an optical disk.

The learned model storage unit 25a stores a learned model learned by the creation unit 14b. For example, the learned model storage unit 25a stores, as a learned model, a back channel generator for estimating a quick response of a listener to a conversation of a speaker.

The control unit 24 includes an internal memory for storing a program defining various processing procedures and the like and required data, and executes various types of processing using the program and the data. For example, the control unit 24 includes an input data acquisition unit 24a and an estimation unit 24b. Here, the control unit 24 is an electronic circuit such as a central processing unit (CPU) or a micro processing unit (MPU), or an integrated circuit such as an application specific integrated circuit (ASIC) or a field programmable gate array (FPGA).

The input data acquisition unit 24a acquires speech data of a speaker and information on the speaker. For example, the input data acquisition unit 24a acquires any one or more of the expression, the motion, and the voice of the speaker as the information on the speaker.

The estimation unit 24b inputs the information acquired by the input data acquisition unit 24a as input data to a learned model of predicting a quick response of the listener from the conversation content of the speaker, and estimates the quick response of the listener with respect to the conversation of the speaker. Then, the estimation unit 24b outputs the estimated quick response information.

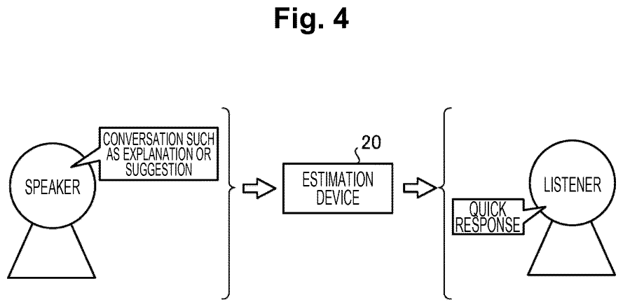

Here, processing of estimating a quick response of a listener to a conversation of a speaker will be described with reference to FIG. 4. FIG. 4 is a diagram illustrating processing of estimating a quick response of a listener to a conversation of a speaker. As illustrated in FIG. 4, the estimation device 20 inputs a multimodal of a speaker to the learned model, and outputs a multimodal including a quick response (speech, speech sentence) of the listener.

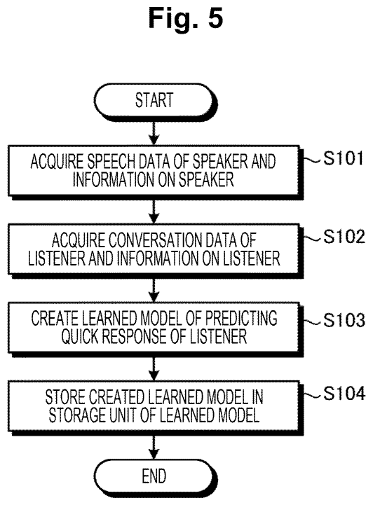

As a result, the estimation device 20 can implement natural conversation continuation of the speaker by naturally and appropriately generating the back channel important in communication according to the multimodal of the speaker.

[Processing Procedure by Learning Device] Next, an example of a processing procedure of processing executed by the learning device 10 will be described with reference to FIG. 5. FIG. 5 is a flowchart illustrating an example of a processing procedure of pre-processing.

As illustrated in FIG. 5, the learning data acquisition unit 14a of the learning device 10 acquires speech data of a speaker and information on the speaker (step S101). Then, the learning data acquisition unit 14a acquires conversation data of the listener and information on the listener (step S102).

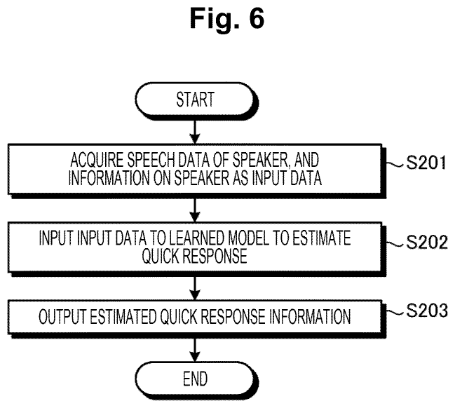

Then, the creation unit 14b uses the information acquired by the learning data acquisition unit 14a to create a learned model of predicting a quick response of the listener to the conversation of the speaker using the quick response included in the conversation data of the listener as correct answer data (step S103). Thereafter, the creation unit 14b stores the created learned model in the learned model storage unit 15a (step S104).

[Processing Procedure by Estimation Device] Next, an example of a processing procedure of processing executed by the estimation device 20 will be described with reference to FIG. 6. FIG. 6 is a flowchart illustrating an example of a processing procedure of estimation processing.

As illustrated in FIG. 6, the input data acquisition unit 24a of the estimation device 20 acquires the speech data of the speaker, and the information on the speaker as input data (step S201). Then, the estimation unit 24b inputs the input data to the learned model, estimates the quick response of the listener to the conversation of the speaker (step S202), and outputs the estimated quick response information (step S203).

[Effects of Embodiment] As described above, the learning device 10 according to the embodiment acquires speech data of a speaker, information on the speaker, conversation data of a listener, and information on the listener, and creates a learned model of estimating a quick response of the listener to a conversation of the speaker using the acquired information with a quick response included in the conversation data of the listener as correct answer data. Therefore, the learning device 10 can generate a learned model capable of estimating a more natural quick response as a listener. Furthermore, the estimation device 20 acquires speech data of a speaker, and information on the speaker, and inputs the acquired information as input data to a learned model of predicting a quick response of the listener from a conversation content of the speaker and estimates the quick response of the listener to the conversation of the speaker. Therefore, the estimation device 20 can generate a more natural quick response as a listener.

That is, the estimation device 20 can estimate a natural and appropriate back channel by using the multimodal of the speaker as an input. As described above, the learning device 10 can learn a quick response of the listener with respect to the speech of the speaker. Then, the estimation device 20 can generate a back channel (quick response) having more appropriate contents, and can generate a more natural reaction as a listener.

### [System Configuration and the Like]

Each component of each device illustrated according to the above embodiments is functionally conceptual and does not necessarily have to be physically configured as illustrated. That is, a specific form of distribution and integration of each device is not limited to the illustrated form, and all or a part thereof can be functionally or physically distributed and integrated in any unit according to various loads, usage conditions, and the like. Furthermore, all or any part of the processing functions performed in each device can be implemented by a CPU and a program analyzed and executed by the CPU, or can be implemented as hardware by wired logic.

Furthermore, among the processing described in the above embodiments, all or a part of the processing described as being automatically performed can be manually performed, or all or a part of the processing described as being manually performed can be automatically performed by a known method. In addition, the processing procedures, the control procedures, the specific names, and the information including various data and parameters illustrated in the above document and drawings can be arbitrarily changed unless otherwise specified.

### [Program]

In addition, it is also possible to create a program in which the processing to be executed by the learning device 10 or the estimation device 20 described in the embodiment described above is described in a language that can be executed by a computer. In this case, the computer executes the program, and thus the effects similar to those of the above embodiments can be obtained. Furthermore, the program may be recorded in a computer-readable recording medium, and the program recorded in the recording medium may be read and executed by the computer to implement processing similar to that of the above embodiments.

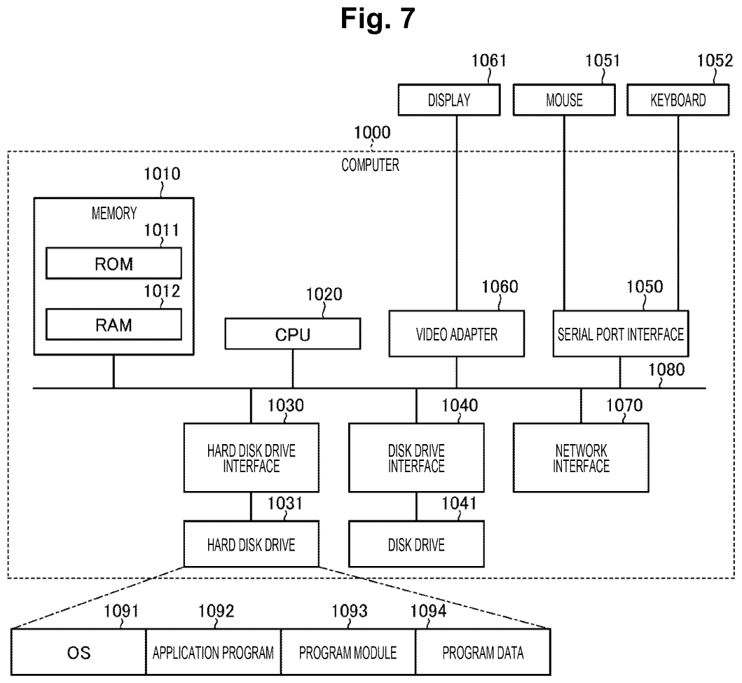

FIG. 7 is a diagram illustrating a computer that executes a program. As illustrated in FIG. 7, a computer 1000 includes, for example, a memory 1010, a CPU 1020, a hard disk drive interface 1030, a disk drive interface 1040, a serial port interface 1050, a video adapter 1060, and a network interface 1070, and these units are connected by a bus 1080.

As exemplified in FIG. 7, the memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031 as illustrated in FIG. 7. The disk drive interface 1040 is connected to a disk drive 1041 as illustrated in FIG. 7. For example, a removable storage medium such as a magnetic disk or an optical disc is inserted into the disk drive 1041. As illustrated in FIG. 7, the serial port interface 1050 is connected to, for example, a mouse 1051 and a keyboard 1052. As illustrated in FIG. 7, the video adapter 1060 is connected to, for example, a display 1061.

Here, as illustrated in FIG. 7, the hard disk drive 1031 stores, for example, an OS 1091, an application program 1092, a program module 1093, and program data 1094. That is, the above program is stored as a program module in which a command executed by the computer 1000 is described, for example, in the hard disk drive 1031.

In addition, various data described in the above embodiments is stored as program data in, for example, the memory 1010 and the hard disk drive 1031. The CPU 1020 then reads the program module 1093 and the program data 1094 stored in the memory 1010 and the hard disk drive 1031 to the RAM 1012 as necessary, and executes various processing procedures.

Note that the program module 1093 and the program data 1094 related to the program are not limited to being stored in the hard disk drive 1031, and may be stored in, for example, a removable storage medium and read by the CPU 1020 via the disk drive or the like. Alternatively, the program module 1093 and the program data 1094 related to the program may be stored in another computer connected via a network (such as a local area network (LAN) or a wide area network (WAN)) and read by the CPU 1020 via the network interface 1070.

Although the embodiments to which the invention made by the present inventor is applied have been described above, the present invention is not limited by the description and drawings constituting a part of the disclosure of the present invention according to the present embodiments. In other words, other embodiments, examples, operational techniques, and the like made by those skilled in the art or the like on the basis of the present embodiment are all included in the scope of the present invention.

### REFERENCE SIGNS LIST

10 Learning device
11, 21 Communication processing unit
12, 22 Input unit
13, 23 Output unit
14, 24 Control unit
14a Learning data acquisition unit
14b Creation unit
15, 25 Storage unit
15a, 25a Learned model storage unit
24a Input data acquisition unit
24b Estimation unit

1. A learning device comprising:
processing circuitry configured to:
acquire speech data of a speaker, information on the speaker, conversation data of a listener, and information on the listener; and
create a learned model of estimating a quick response of the listener to a conversation of the speaker using the information acquired with a quick response included in the conversation data of the listener as correct answer data.

2. The learning device according to claim 1, wherein the processing circuitry is further configured to acquire any one or more of an expression, a motion, and voice of the speaker as the information on the speaker, and acquire any one or more of the expression, the motion, and the voice of the speaker as the information on the listener.

3.-4. (canceled)

5. A learning method performed by a learning device, the learning method comprising:
of acquiring speech data of a speaker, information on the speaker, conversation data of a listener, and information on the listener; and
creating a learned model of estimating a quick response of the listener to a conversation of the speaker using the information acquired with a quick response included in the conversation data of the listener as correct answer data.

6. (canceled)

7. A non-transitory computer-readable recording medium storing therein a learning program that causes a computer to execute a process comprising:
acquiring speech data of a speaker, information on the speaker, conversation data of a listener, and information on the listener; and
creating a learned model of estimating a quick response of the listener to a conversation of the speaker using the information acquired with a quick response included in the conversation data of the listener as correct answer data.

8. (canceled)
